(19) United States
(12) Patent Application Publication
(10) Pub. No.: US 2024/0135508 A1
(43) Pub. Date: Apr. 25, 2024

(54) IMAGE PROCESSING METHOD, IMAGE PROCESSING APPARATUS, IMAGE PROCESSING SYSTEM, IMAGING APPARATUS, AND STORAGE MEDIUM

(71) Applicant: CANON KABUSHIKI KAISHA, Tokyo (JP)

(72) Inventors: YOSHIAKI IDA, Tokyo (JP); NORIHITO HIASA, Tochigi (JP); YUICHI KUSUMI, Tochigi (JP); MASAKAZU KOBAYASHI, Saitama (JP)

(21) Appl. No.: 18/485,990

(22) Filed: Oct. 12, 2023

(30) Foreign Application Priority Data
Oct. 17, 2022 (JP) 2022-166377
Nov. 29, 2022 (JP) 2022-190038

(51) Int. Cl. G06T 5/00; G06T 5/20; H04N 23/81

(52) U.S. Cl. CPC G06T 5/003; G06T 5/20; H04N 23/81

(57) ABSTRACT

An image processing method includes acquiring a captured image obtained by image capturing using an optical system, acquiring correction strength for a sharpening process applied to a partial area in the captured image, and applying the sharpening process to the partial area based on a first optical characteristic and the correction strength, wherein the correction strength is acquired based on a second optical characteristic, wherein the first optical characteristic is an optical characteristic of the optical system in a case where the optical system is defocused by a first defocus amount, wherein the second optical characteristic is an optical characteristic of the optical system in a case where the optical system is defocused by a second defocus amount, and wherein the second defocus amount is smaller than the first defocus amount.

### BACKGROUND

### Technical Field

The aspect of the embodiments relates to an image processing apparatus that performs a sharpening process on an image.

### Description of the Related Art

In image capturing using an optical system, light generated from a single point of a subject reaches an image plane with slight spread under the influence of diffraction and aberration that occur in the optical system. Thus, in a captured image, the higher the image height at the position is, the more likely blur is to occur. Such blur of the captured image is corrected by a sharpening process based on an optical characteristic of the optical system, such as the point spread function (PSF) or the optical transfer function (OTF).

Japanese Patent Application Laid-Open No. 2013-038563 discusses a method for generating the OTF with respect to each image height based on the OTF when an optical system focuses on the optical axis and coefficient data, and sharpening an image based on the OTF with respect to each image height.

If a subject captured by an imaging apparatus is a three-dimensional object having a depth, an optical characteristic changes according to the difference in the depth of the subject (the subject distance). If an optical system has aberration (field curvature or astigmatism) in which an image forming point is shifted in the vertical (optical axis) direction with respect to an image plane, the blur of a subject present at a depth different from a focusing plane may be small.

The method of Japanese Patent Application Laid-Open No. 2013-038563 does not take into account the depth of a subject with respect to each image height of the subject. Thus, if blur at a certain image height is smaller than blur assumed based on the coefficient data due to the depth of the subject, the blur is excessively corrected at the position of the certain image height. The blur is excessively corrected in a sharpening process, whereby an adverse effect such as underexposure or ringing may occur in an image after the process.

### SUMMARY

According to an aspect of the embodiments, an image processing method includes acquiring a captured image obtained by image capturing using an optical system, acquiring correction strength for a sharpening process applied to a partial area in the captured image, and applying the sharpening process to the partial area based on a first optical characteristic and the correction strength. The correction strength is acquired based on a second optical characteristic. The first optical characteristic is an optical characteristic of the optical system in a case where the optical system is defocused by a first defocus amount, the second optical characteristic is an optical characteristic of the optical system in a case where the optical system is defocused by a second defocus amount, and the second defocus amount is smaller than the first defocus amount.

Further features of the disclosure will become apparent from the following description of exemplary embodiments with reference to the attached drawings.

### BRIEF DESCRIPTION OF THE DRAWINGS

FIG. 1 is a diagram illustrating an image forming relationship based on an optical system in a case where the optical system focuses on an on-axis object point.

FIG. 2 is a diagram illustrating an image forming relationship based on the optical system in a case where the optical system focuses on an off-axis object point.

FIG. 3 is a block diagram of an imaging apparatus according to exemplary embodiments.

FIG. 4 is a flowchart illustrating image processing according to first and second exemplary embodiments.

FIG. 5 is a diagram illustrating a change in a modulation transfer function (MTF) with respect to a depth of a subject according to the first exemplary embodiment and a third exemplary embodiment.

FIG. 6 is a diagram illustrating correction strength according to the first exemplary embodiment.

FIG. 7 is a diagram illustrating a change in an MTF with respect to a depth of a subject according to the second exemplary embodiment and a fourth exemplary embodiment.

FIG. 8 is a flowchart illustrating image processing according to the third and fourth exemplary embodiments.

FIGS. 9A to 9C are diagrams illustrating correction strength according to the third exemplary embodiment.

FIG. 10 is a diagram illustrating a two-viewpoint imaging method.

FIG. 11 is a diagram illustrating relationships between light-receiving units of an imaging sensor and a pupil of an imaging optical system.

FIG. 12 is a diagram illustrating relationships between the light-receiving units of the imaging sensor and a subject.

### DESCRIPTION OF THE EMBODIMENTS

Exemplary embodiments of the disclosure will be described in detail below with reference to the drawings. In the drawings, the same members are designated by the same reference numbers, and are not redundantly described.

In the present exemplary embodiment, on an input image generated by image capturing using an optical system, a sharpening process using a sharpening filter based on an optical characteristic of the optical system is performed. The optical characteristic according to the present exemplary embodiment indicates the aberration of the optical system or the blur of the input image due to the aberration and changes according to the imaging conditions, the spatial frequency, the image height of the optical system, or the subject defocus amount. Further, examples of the optical characteristic include the point spread function (PSF), the optical transfer function (OTF), the modulation transfer function (MTF), which is the amplitude component of the OTF, and the phase transfer function (PTF), which is the phase component of the OTF.

Next, the sharpening process according to the present exemplary embodiment is described. In the present exemplary embodiment, the sharpening process is an aberration correction process based on the optical characteristic and is also termed an “image recovery process” or a “point image restoration process”.

The optical characteristic may be the characteristics of optical elements including not only an imaging lens but also a low-pass filter and an infrared cut filter, and the influence of a structure such as the pixel array of an image sensor may be taken into account. The sharpening process described here is appropriately used in the following exemplary embodiments.

An overview of the sharpening process is described below. If a captured image (a deteriorating image) is g(x, y), and an original image is f(x, y), and the point spread function (PSF) with which the optical transfer function (OTF) forms a Fourier pair is h(x, y), the following equation (1) holds true.

g(x,y)=h(x,y)*f(x,y) (1)

In this equation, * is convolution (convolution integration or the multiply-accumulate operation), and (x, y) are coordinates on the captured image.

If equation (1) is Fourier-transformed into a display format on a frequency plane, equation (2) represented by the product of frequencies is obtained.

G(u,v)=H(u,v)·F(u,v) (2)

In this equation, H is the optical transfer function (OTF) obtained by Fourier-transforming the point spread function (PSF) (h). G and F are functions obtained by Fourier-transforming the deteriorating image g and the original image f, respectively. (u, v) are coordinates on a two-dimensional frequency plane, i.e., a frequency.

To obtain the original image f from the captured deteriorating image g, both sides may be divided by the optical transfer function H as in the following equation (3).

G(u,v)/H(u,v)=F(u,v) (3)

Then, F(u, v), i.e., G(u, v)/H(u, v), is inverse-Fourier-transformed back into an real plane, whereby the original image f(x, y) is obtained as a recovered image.

If the result of inverse-Fourier-transforming 1/H is R, the original image f(x, y) can be similarly obtained by performing a convolution process on an image on an real plane as in the following equation (4).

g(x,y)*R(x,y)=f(x,y) (4)

In this equation, R(x, y) is termed a “sharpening filter”. If the image is a two-dimensional image, generally, the sharpening filter R is also a two-dimensional filter having taps (cells) corresponding to pixels in the image. Generally, the greater the number of taps (the number of cells) of the sharpening filter R is, the more improved the recovery accuracy is. Thus, the achievable number of taps is set according to the required image quality, the image processing capability, or the characteristics of the aberration. The sharpening filter R is to reflect at least the characteristics of the aberration and therefore is different from a conventional edge enhancement filter with about three taps in each of the horizontal and vertical directions. The sharpening filter R is set based on the optical transfer function (OTF) and therefore can correct both the deterioration of the amplitude component and the deterioration of the phase component with high accuracy.

Since the actual image includes a noise component, if the sharpening filter R created by taking the multiplicative inverse of the optical transfer function (OTF) as described above is used, the noise component is significantly amplified with the recovery of the deteriorating image. This is because the MTF (the amplitude component) of the optical system is raised to return the MTF to 1 over all the frequencies in the state where the amplitude of the noise is added to the amplitude component of the image. Although the MTF corresponding to amplitude deterioration based on the optical system returns to 1, the power spectrum of the noise is also raised at the same time. As a result, the noise is amplified according to the degree of raising the MTF (recovery gain).

Thus, if noise is included in the image, an image excellent as an ornamental image is not obtained. This is represented by the following equations (5-1) and (5-2).

G(u,v)=H(u,v)·F(u,v)+N(u,v) (5-1)

G(u,v)/H(u,v)=F(u,v)+N(u,v)/H(u,v) (5-2)

In these equations, N is a noise component. Regarding the image including the noise component, for example, there is a method for controlling the recovery degree according to the signal-to-noise ratio (SNR), i.e., the intensity ratio, between an image signal and a noise signal as in the Wiener filter represented by the following equation (6).

M(u,v)=1/H(u,v)·(|H(u,v)|\hat{ }2)/(|H(u,v)|\hat{ }2+SNR\hat{ }2) (6)

In this equation, M(u, v) is the frequency characteristic of the Wiener filter, and |H(u, v)| is the absolute value (the MTF) of the optical transfer function (OTF). In this method, with respect to each frequency, the smaller the MTF is, the smaller the recovery gain (the recovery degree) is. Then, the greater the MTF is, the greater the recovery gain is. Generally, the MTF of the optical system is higher on the low-frequency side and lower on the high-frequency side. Thus, in this method, the recovery gain on the high-frequency side of the image is substantially reduced.

As described above, the sharpening filter can be obtained by inverse-Fourier-transforming the function designed based on the inverse function of the optical transfer function (OTF) of the optical system. The sharpening filter that can be used in the sharpening process according to the present exemplary embodiment can be appropriately changed, and for example, the Wiener filter as described above can be used. In a case where the Wiener filter is used, a sharpening filter in real space to be actually convolved into the image can be created by inverse-Fourier-transforming equation (6).

The optical transfer function (OTF) changes according to the image height of the optical system (the position in the image) even in a single imaging state. Thus, the sharpening filter is used by changing the sharpening filter according to the image height.

The sharpening process using the sharpening filter is not limited to a process based on the inverse function of the optical transfer function, and may be a process based on an optical characteristic with respect to each imaging condition. For example, the sharpening process may be a sharpening process using a filter based on the PSF as a blurring filter for unsharp mask processing.

The sharpening process is not limited to the convolution of a single sharpening filter. For example, a sharpening process using machine learning may be performed. To perform the sharpening process using machine learning, with an original image corresponding to a subject as a ground truth image, a training image obtained by applying blur based on the optical transfer function to the original image is generated. As a machine learning model, for example, a neural network can be used. At this time, a sharpened image is estimated based on the training image using the neural network, and the machine learning model can be optimized so that the difference between the estimated sharpened image and the ground truth image is small. The ground truth image and the training image is to have a relationship that enables the correction of blur due to an optical characteristic. The ground truth image and the training image may be different from each other in a condition such as the presence or absence of noise, the presence or absence of a development process, or resolution.

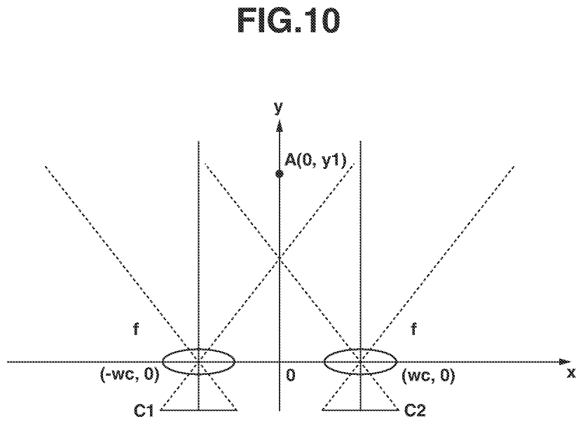

Next, the principle of the calculation of the subject distance using parallax images is described. FIG. 10 is a diagram illustrating a model of a two-viewpoint imaging method. A coordinate system is defined such that with the origin at the midpoint between left and right cameras, an x-axis is set in the horizontal direction, and a y-axis is set in the depth direction. The height direction is omitted for simplicity. The principal points of image forming optical systems of the left and right cameras are placed at (−Wc, 0) and (Wc, 0), respectively. The focal lengths of the image forming optical systems of the left and right cameras are f. It is assumed that a subject A at (0, y1) on the y-axis is captured by each camera in this state. If the amounts of shift in the images of the subject A from the centers of sensors of the left and right cameras are Plc and Prc, respectively, the parallax in the image capturing can be represented by the following equations.

$$Prc = \frac{wc}{y 1} \cdot f \qquad ( 7 )$$

$$Ptc = - \frac{w c}{y 1} \cdot f \qquad ( 8 )$$

The same subject is captured from different viewpoints based on the above principle, whereby left and right parallax images having the amounts of shift represented by equations (7) and (8) in the shift (base line) directions of the viewpoint positions (the parallax directions) can be acquired. At this time, a distance y1 to the subject A can be calculated by the following equation (9).

$$y 1 = - \frac{2 w c}{Prc - Plc} \cdot f \qquad ( 9 )$$

In the present exemplary embodiment, the amount of parallax shift is considered based on a focusing plane. Thus, the amount of parallax shift with respect to a predetermined subject is obtained by subtracting the amount of parallax shift with respect to the subject in focus from the difference between the amounts of shift Prc and Plc corresponding to the subject. The distance from the imaging sensor to the focus (an image forming point) of each image forming optical system (the subject defocus amount) is acquired as a value obtained by multiplying the amount of parallax shift by a predetermined conversion coefficient. The conversion coefficient is determined according to the amount of positional shift in the viewpoint. The amount of parallax shift and the subject defocus amount are signed amounts that can take positive and negative values. In the present exemplary embodiment, if the focus of the image forming optical system is located on the imaging sensor, the value is 0. If the focus of the image forming optical system is located further on the object side than the imaging sensor, the value is negative.

Thus, a corresponding subject area is identified between the parallax images, whereby it is possible to calculate the subject distance using the parallax images. As a method for identifying the same subject area between images, various methods can be used. For example, a block matching method for determining one of the parallax images as a reference image may be used. With this method, it is possible to acquire the amount of parallax shift and acquire the subject defocus amount. The method for acquiring the subject distance is not limited to the above, and for example, the subject defocus amount may be directly acquired from the parallax images by machine learning.

Parallax images can also be acquired using an imaging unit that guides a plurality of beams passing through areas different from each other in a pupil of a single imaging optical system to light-receiving units (pixels) different from each other in a single imaging sensor and causes the light-receiving units to photoelectrically convert the plurality of beams. That is, a single imaging unit (composed of a single optical system and a single imaging sensor) can acquire parallax images required to calculate the distance.

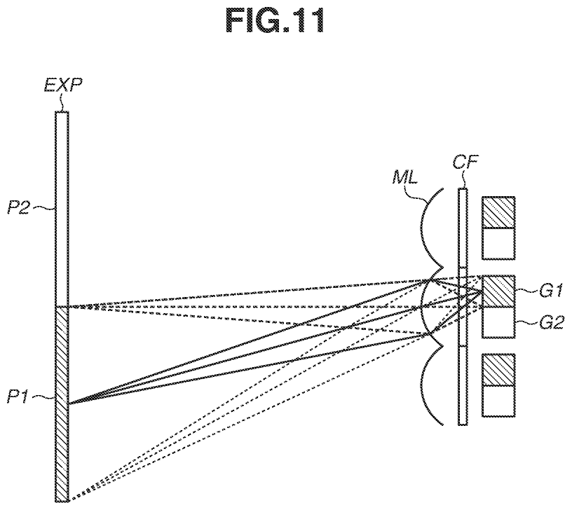

FIG. 11 illustrates the relationships between light-receiving units of an imaging sensor and a pupil of an imaging optical system in such an imaging unit. ML represents microlenses, and CF represents color filters. EXP represents the exit pupil of the imaging optical system. G1 and G2 represent light-receiving units (hereinafter referred to as a “G1 pixel” and a “G2 pixel”), and a single G1 pixel and a single G2 pixel are paired with each other. In the imaging sensor, a plurality of pairs of a G1 pixel and a G2 pixel (pixel pairs) is arranged. The G1 pixel and the G2 pixel included in each pixel pair have an approximately conjugate relationship with the exit pupil EXP through a common microlens ML (i.e., provided with respect to each pixel pair). The plurality of G1 pixels arranged in the imaging sensor is also collectively referred to as a “G1 pixel group”. Similarly, the plurality of G2 pixels arranged in the imaging sensor is also collectively referred to as a “G2 pixel group”.

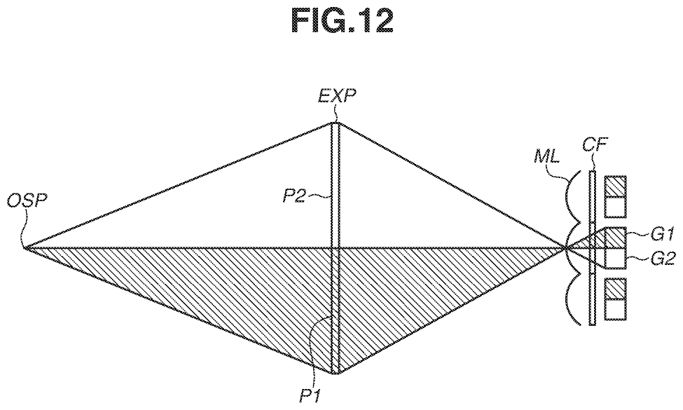

FIG. 12 schematically illustrates the imaging unit in a case where it is assumed that a thin lens is present at the position of the exit pupil EXP in FIG. 11. A G1 pixel receives a beam passing through a P1 area in the exit pupil EXP, and a G2 pixel receives a beam passing through a P2 area in the exit pupil EXP. OSP represents an object point that is being captured. An object does not necessarily need to be present at the object point OSP, and a beam passing through this point is incident on the G1 pixel or the G2 pixel according to the area (the position) in the pupil through which the beam passes.

The state where beams pass through areas different from each other in the pupil is equivalent to the state where incident light from the object point OSP is separated according to the angle (the parallax). That is, an image generated using an output signal from the G1 pixel and an image generated using an output signal from the G2 pixel among the plurality of G1 and G2 pixels provided for the microlenses ML are a plurality of (in this case, a pair of) parallax images having a parallax from each other.

In the following description, the state where light-receiving units (pixels) different from each other receive beams passing through areas different from each other in the pupil is also referred to as “pupil division”. Although an example has been described where the pupil is divided into two areas in a single pupil division direction, the pupil division directions and the number of divisions are optional. For example, the pupil may be divided in two directions, namely the horizontal direction and the vertical direction. The pupil division directions and the number of divisions may differ according to the pixel position in the imaging sensor. In the pupil division method, the parallax directions are positional shift directions in a case where the divided pupils are regarded as respective viewpoints. The viewpoint positions are defined based on pupil areas through which beams pass, and for example, may be the positions of the centers of gravity of the beams. The pupil division directions are not limited to the horizontal direction and the vertical direction, and may be an oblique direction.

In FIGS. 11 and 12, even if the above conjugation relationship is not complete or the P1 and P2 areas partially overlap each other due to a shift in the position of the exit pupil EXP, a plurality of obtained images can be treated as parallax images.

Also in the pupil division method, the amount of parallax shift and the subject defocus amount can be acquired similarly to the two-viewpoint imaging method. The distance from the imaging sensor to the focus of each image forming optical system (the subject defocus amount) can be acquired as a value obtained by multiplying the amount of parallax shift by a predetermined conversion coefficient. The conversion coefficient is determined according to the amount of positional shift in the viewpoint.

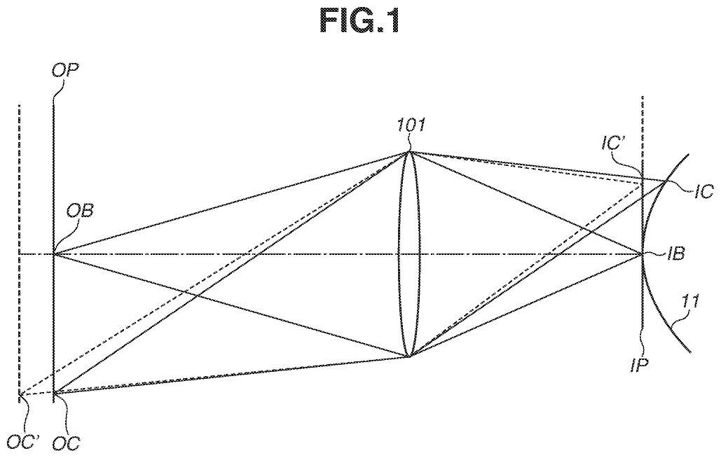

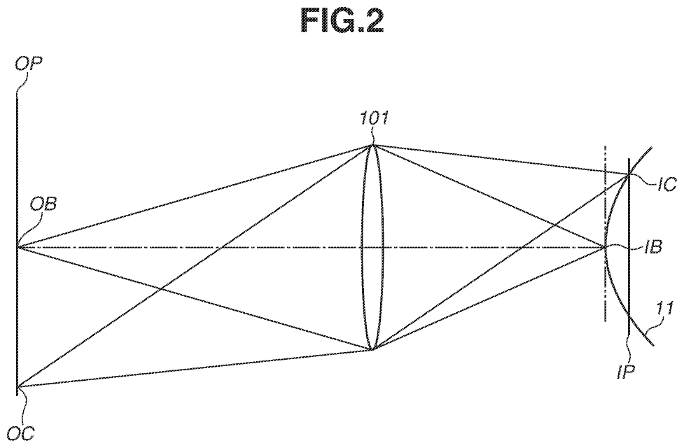

Next, with reference to FIGS. 1 and 2, excessive correction in the sharpening process (blur correction) on a captured image is described. FIG. 1 is a diagram illustrating an image forming relationship based on an optical system in a case where the optical system focuses on an on-axis object point OB. FIG. 2 is a diagram illustrating an image forming relationship based on the optical system in a case where the optical system focuses on an off-axis object point OC. FIGS. 1 and 2 illustrate only marginal rays and omit other rays.

The present exemplary embodiment is directed to preventing excessive correction in the sharpening process performed based on an optical characteristic defocused by a first defocus amount (a first optical characteristic). Accordingly, in the present exemplary embodiment, correction strength is acquired based on an optical characteristic defocused by a second defocus amount (a second optical characteristic), and the sharpening process is performed based on the first optical characteristic and the correction strength. Each of the first defocus amount and the second defocus amount is an amount of shift between an image position and an image forming position for acquisition of the optical characteristic. An optical system 101 according to the present exemplary embodiment has field curvature. The field curvature amount of the optical system 101 at any image height (a first image height) is a first defocus amount. Further, when the optical system 101 focuses on an object point corresponding to any image height (the first image height), the amount of shift between the focus position (the focusing position) at the first image height and the image plane is a second defocus amount. The first defocus amount is not necessarily the field curvature amount, and may be set as a value that determines an optical characteristic used for the sharpening process.

Ideally, the second defocus amount is zero. In the present exemplary embodiment, however, “image forming” and “focusing” may not be image forming and focusing based on an optical paraxial theory. Alternatively, for example, “image forming” and “focusing” may be the state where the value of the spread of an optical image forming spot (the PSF) due to the aberration is smallest. Yet alternatively, “image forming” and “focusing” may be the state where the value of the MTF at a particular spatial frequency is greatest. In the present exemplary embodiment, “conjugation” may not be a relationship determined based on the optical paraxial theory. For example, “conjugation” may be a relationship where the optical transfer function (OTF) is most excellent based on a predetermined reference.

In FIG. 1, the object point OB is on the intersection point of an object plane OP and the optical axis of the optical system 101, and the optical system 101 forms an image of the object point OB at an image point IB on an image plane IP conjugate with the object point OB. Since the optical system 101 focuses on the object point OB, the image point IB is located on the image plane IP. The image plane IP is at the same position as an image sensor. The object point OC is present at a position that is on the object plane OP and is not on the optical axis. The optical system 101 forms an image of the object point OC at an image point IC conjugate with the object point OC. The object point OC has a first object height, and the image point IC has the first image height.

The image point IC is not located on the image plane IP due to the field curvature, and is shifted (defocused) in the propagation direction of a ray. A surface 11 is an image forming position with respect to each object height on the object plane OP due to the field curvature of the optical system 101. The distance between the image plane IP and the surface 11 is the field curvature amount of the optical system 101 with respect to each image height, and corresponds to the first defocus amount.

An object point OC′ has the same object height as the object point OC and is located at a depth different from that of the object point OC (has a subject distance) with respect to the image plane IP. The optical system 101 forms an image of the object point OC′ at an image point IC′ on the image plane IP. If a subject is present at the object point OC′ in FIG. 1, the defocus amount at the image point IC′ is 0, and blur due to the field curvature does not occur at the image point IC′.

In the conventional art (Japanese Patent Application Laid-Open No. 2013-038563), however, even if a subject is located at the object point OC′, the sharpening process is performed based on an optical characteristic with respect to the object point OC on the object plane OP. At this time, excessive correction occurs in a partial area including the image point IC′ where blur does not occur. This causes an adverse effect on image quality, such as undershoot or ringing. Although the object point OC′ with which the defocus amount is 0 has been taken as an example, if a subject makes the defocus amount from the image plane IP small with respect to the object point OC corresponding to an optical characteristic used in the sharpening process, excessive correction may similarly occur.

Next, FIG. 2 is described. FIG. 2 is a diagram illustrating an image forming relationship based on the optical system in a case where the optical system focuses on the off-axis object point OC. Contents similar to those in FIG. 1 are not described.

Since the optical system 101 having distortion focuses on the object point OC, the image point IC is located on the intersection point of the image plane IP and the surface 11. Thus, the defocus amount of the optical system 101 at the image point IC is 0, and blur due to the field curvature does not occur at the image point IC. If the optical characteristic used for the sharpening process is changed with respect to each focusing position, the amount of data of the optical characteristic becomes large. Thus, the sharpening process is performed based on the optical characteristic corresponding to the distance to a subject in focus in some cases. However, even if the distance to a subject in focus is the same as that in a case of focusing on an on-axis subject, blur with respect to the angle of view of the object point OC is small, and thus, excessive correction may occur in the sharpening process. It is the same as in the above described case in that the depth of the subject position corresponding to the optical characteristic used for the sharpening process is different from the depth of the actual subject. In a case where the blur of the image point is larger than that assumed in the sharpening process, an adverse effect due to excessive correction does not occur.

In the conventional art (Japanese Patent Application Laid-Open No. 2013-038563), however, the intensity of the sharpening process is set so that the higher the image height at the position is, the higher the intensity of the sharpening process is. Thus, the process is performed with higher intensity at the image point IC than at the image point IB even though blur is less at the image point IC than at the image point IB. At this time, excessive correction occurs in a partial area including the image point IC where blur does not occur. This causes an adverse effect on image quality, such as undershoot or ringing.

The present exemplary embodiment is directed to preventing excessive correction in the sharpening process performed based on an optical characteristic defocused by the first defocus amount (a first optical characteristic). Accordingly, in the present exemplary embodiment, correction strength is acquired based on an optical characteristic defocused by the second defocus amount (a second optical characteristic), and the sharpening process is performed based on the first optical characteristic and the correction strength. In the present exemplary embodiment, the optical characteristic (first optical characteristic) used for the sharpening process can be defined with respect to any object point and an image point corresponding to the object point. For example, the object plane OP and the image plane IP may be a curved surface such as a spherical surface. The position on which the optical system 101 focuses may not be on the axis.

The second defocus amount according to the present exemplary embodiment is the difference (the distance) between the focusing position and the image plane when the optical system 101 focuses on an object point having the first object height. Ideally, the second defocus amount is zero. At the focusing position, the optical system 101 has the highest-performance optical characteristic at the image height. That is, the optical system 101 is in the least blurred state. In the present exemplary embodiment, the correction strength is acquired based on the optical characteristic in the least blurred state (the second optical characteristic), whereby it is possible to prevent excessive correction in the sharpening process based on the first optical characteristic. To prevent excessive correction in the sharpening process, the second defocus amount may not be exactly zero so long as the second defocus amount is smaller than the first defocus amount. Alternatively, optical characteristics may be obtained at discretely set image plane positions, and the defocus amount corresponding to the highest-performance optical characteristic may be set as the second defocus amount.

Although the optical system 101 according to the present exemplary embodiment is rotationally symmetric, the disclosure, however, is not limited to this, and the optical system 101 may be rotationally asymmetric.

The above image processing method is merely an example, and the disclosure is not limited to this. The details of other image processing methods will be described in the following exemplary embodiments.

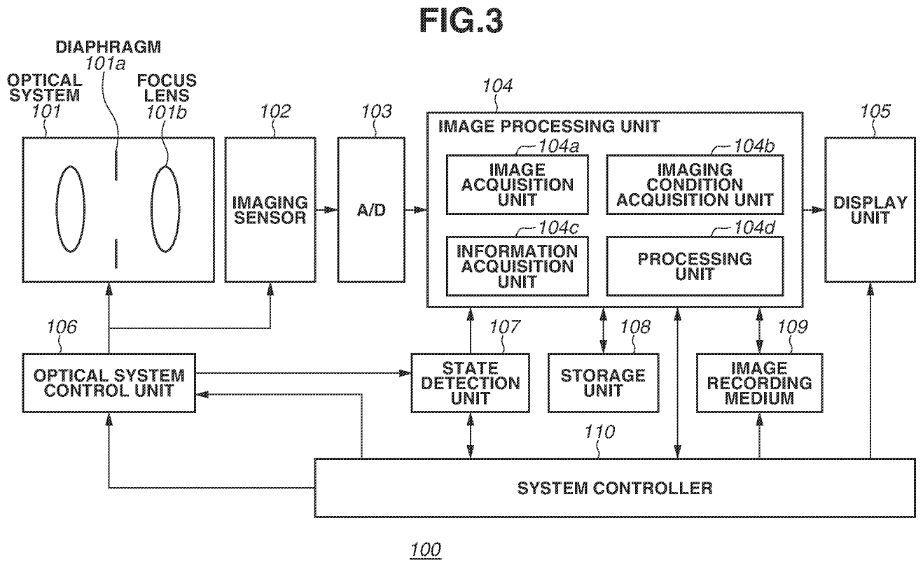

Next, the configuration of an imaging apparatus according to a first exemplary embodiment is described. With reference to FIG. 3, an imaging apparatus 100 according to the present exemplary embodiment is described. FIG. 3 is a block diagram illustrating the configuration of the imaging apparatus 100. On the imaging apparatus 100, an image processing program for performing a sharpening process according to the present exemplary embodiment is installed. The sharpening process according to the present exemplary embodiment is executed by an image processing unit (image processing apparatus) 104 within the imaging apparatus 100 having an imaging unit including an optical system 101.

The imaging apparatus 100 includes an optical system (imaging optical system) 101 and an imaging apparatus main body (a camera main body). The optical system 101 includes a diaphragm 101a and a focus lens 101b and is formed integrally with the camera main body. The aspect of the embodiments, however, is not limited to this, and is also applicable to an imaging apparatus in which the optical system 101 is detachably attached to the camera main body. In addition to an optical element having a refractive surface such as a lens, the optical system 101 may also include an optical element having a diffractive surface and an optical element having a reflective surface.

An imaging sensor 102 includes a charge-coupled device (CCD) sensor or a complementary metal-oxide-semiconductor (CMOS) sensor. The imaging sensor 102 photoelectrically converts a subject image formed through the optical system 101 (an optical image formed by the optical system 101), thereby generating (outputting) a captured image (image data). That is, the subject image is photoelectrically converted into an analog signal (an electric signal) by the imaging sensor 102. An analog-to-digital (A/D) converter 103 converts the analog signal input from the imaging sensor 102 into a digital signal and outputs the digital signal to an image processing unit 104.

The image processing unit 104 performs a predetermined process on the digital signal and also performs the sharpening process according to the present exemplary embodiment on the digital signal. The image processing unit 104 includes an image acquisition unit 104a, an imaging condition acquisition unit 104b, an information acquisition unit 104c, and a processing unit 104d. The image acquisition unit 104a acquires the captured image from the A/D converter 103. The imaging condition acquisition unit 104b acquires the imaging conditions of the imaging apparatus 100 from a state detection unit 107. The imaging conditions are the stop value, the imaging distance (the focus position), and the focal length of a zoom lens. The state detection unit 107 may directly acquire the imaging conditions from a system controller 110, or may acquire the imaging conditions from an optical system control unit 106. In the processing of the image processing unit 104, the function of the image processing unit 104 can be implemented by a processor (a processing method) such as one or more central processing units (CPUs).

The optical transfer function (OTF) or data required to generate the OTF is held in a storage unit (storage method) 108. For example, the storage unit 108 is composed of a read-only memory (ROM). The output image processed by the image processing unit 104 is saved in a predetermined format in an image recording medium 109. A display unit 105 composed of a liquid crystal monitor or an organic electroluminescent (EL) display displays an image obtained by performing a predetermined process for display on the image subjected to the sharpening process. The image displayed on the display unit 105, however, is not limited to this, and the display unit 105 may display an image subjected to a simple process for high-speed display.

The system controller 110 controls the imaging apparatus 100. The optical system 101 is mechanically driven by the optical system control unit 106 based on an instruction from the system controller 110. The optical system control unit 106 controls the aperture diameter of the diaphragm 101a to obtain a predetermined F-number. To adjust the focus according to the subject distance, the optical system control unit 106 controls the position of the focus lens 101b using an autofocus (AF) mechanism or a manual focus mechanism (not illustrated). The control of the aperture diameter of the diaphragm 101a and the function of the manual focus or the like may not be executed according to the specifications of the imaging apparatus 100.

In one embodiment, an optical element such as a low-pass filter or an infrared cut-off filter may be placed between the optical system 101 and the imaging sensor 102. If, however, an element that influences an optical characteristic, such as a low-pass filter, is used, it may be necessary to make consideration at the time when a sharpening filter is created. An infrared cut-off filter also influences the optical transfer functions (OTFs) of red, green, and blue (RGB) channels that are the integral values of the OTFs of spectroscopic wavelengths, particularly, the OTF of the R channel, and therefore, it may be necessary to make consideration at the time when the sharpening filter is created. Thus, the sharpening filter may be changed according to the presence or absence of a low-pass filter or an infrared cut-off filter.

The image processing unit 104 is composed of an application-specific integrated circuit (ASIC). Each of the optical system control unit 106, the state detection unit 107, and the system controller 110 is composed of a CPU or a microprocessor unit (MPU). Alternatively, one or more of the image processing unit 104, the optical system control unit 106, the state detection unit 107, and the system controller 110 may be composed of the same CPU or MPU.

The imaging apparatus 100 is not limited to this. For example, an image processing method according to the present exemplary embodiment may be performed by an image processing system including an imaging apparatus and an image processing apparatus (corresponding to the image processing unit 104) provided separately from the imaging apparatus. At this time, the imaging apparatus outputs an input image to the image processing apparatus, and the image processing apparatus performs image processing described below on the input image. In one embodiment, the imaging apparatus attaches imaging condition information and information required for correction including optical information to the input image. The imaging condition information and the correction information may be directly or indirectly transmitted from the imaging apparatus to the image processing apparatus through communication, instead of being attached to the input image when output.

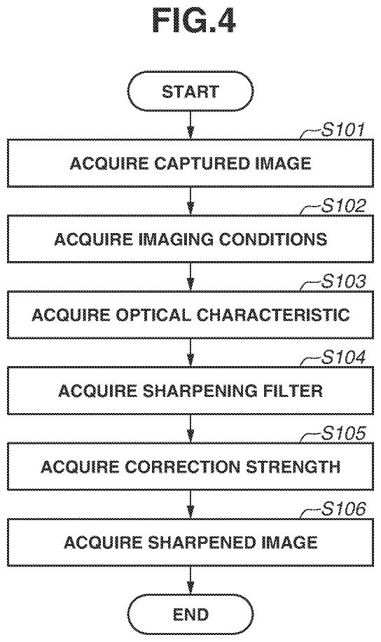

The sharpening process performed by the image processing unit 104 is specifically described below in exemplary embodiments. FIG. 4 is a flowchart regarding the sharpening process according to the first exemplary embodiment. The sharpening process according to the first exemplary embodiment is executed based on an instruction from the image processing unit 104. Steps in FIG. 4 are mainly executed by the image acquisition unit 104a, the imaging condition acquisition unit 104b, the information acquisition unit 104c, and the processing unit 104d.

In step S101, the image acquisition unit 104a acquires an image captured by the imaging apparatus 100 as an input image. The input image is saved in the storage unit 108. Alternatively, the image acquisition unit 104a may acquire an image saved in the image recording medium 109 as the input image.

In step S102, the imaging condition acquisition unit 104b acquires the imaging conditions when the input image is captured. The imaging conditions include the focal length of the optical system 101, the stop value, and the imaging distance determined with respect to a subject in focus. In the case of an imaging apparatus in which a lens is interchangeably attached to a camera main body, the imaging conditions may further include a lens identifier (ID) and a camera ID. The imaging conditions may be directly acquired from the imaging apparatus 100, or may be acquired from information attached to the input image. For example, the information attached to the input image is exchangeable image file format (Exif) information.

In step S103, the information acquisition unit 104c acquires an optical characteristic (the first optical characteristic) of the optical system 101 from the storage unit 108. The first optical characteristic is an optical characteristic of the optical system 101 when the optical system 101 is defocused by the first defocus amount. The first defocus amount is a value based on the aberration of the optical system 101 and differs with respect to each image height. As the optical characteristic, for example, the OTF, the PSF, or coefficient data of a function approximately representing the PSF or the OTF may be acquired. Further, in the present exemplary embodiment, the aberration is field curvature. The aberration is not limited to this, and may include astigmatism. The storage unit 108 may discretely store optical characteristics for imaging conditions and screen positions (image heights and bearings), and an optical characteristic in each partial area may be acquired using the interpolations of the imaging conditions and the screen positions.

In step S104, the processing unit 104d acquires a sharpening filter. In the present exemplary embodiment, the sharpening filter is acquired based on the first optical characteristic at a position corresponding to each partial area using equation (6). The first optical characteristic at each position in the input image differs, and therefore, the sharpening filter applied to each position in the input image differs.

In step S105, the information acquisition unit 104c acquires correction strength. The correction strength according to the present exemplary embodiment is acquired from the storage unit 108 based on the second optical characteristic. In the present exemplary embodiment, the second optical characteristic is an optical characteristic of the optical system 101 when the optical system 101 is defocused by the second defocus amount. The second defocus amount in a certain partial area or at a certain image height (object height) is different from the first defocus amount. Further, in one embodiment, the second defocus amount is to be smaller than the first defocus amount. With this configuration, it is possible to reduce an adverse effect in the sharpening process on the image.

Step S105 in the present exemplary embodiment may be executed, regardless of whether before, between, or after steps S103 and S104.

In step S106, based on the sharpening filter and the correction strength, the processing unit 104d executes the sharpening process. In the sharpening process, first, the processing unit 104d convolves the sharpening filter into the input image, thereby acquiring an intermediate output image obtained by sharpening the input image. Then, the processing unit 104d obtains a weighted sum of the input image and the intermediate output image based on the correction strength, thereby adjusting a correction effect.

In the sharpening process according to the present exemplary embodiment, the blur is corrected due to the first optical characteristic based on the first optical characteristic. Therefore, in order to effectively correct the blur due to the first optical characteristic, in one embodiment, at least one of the frequency dependency, the phase component of the OTF, and the difference of the optical characteristic due to the azimuth direction is considered. In addition, since the optical characteristic is different depending on the imaging conditions such as the zooming position, the stop value, and the imaging distance, in one embodiment, the blur is corrected in consideration of changes in the optical characteristic due to the imaging conditions. Alternatively, a machine learning model may be used in the sharpening process. The machine learning model is trained using learning data including a ground truth image and a training image that are different in the presence or absence of blur due to an optical characteristic. Also in the sharpening process using the machine learning model, the correction strength based on the second optical characteristic is used, whereby it is possible to prevent excessive correction in the sharpening process that occurs due to the depth of the subject.

In a case where the sharpening process using the machine learning model is performed, the information acquisition unit 104c acquires a parameter (weight information) of the machine learning model. At this time, the machine learning model acquires an intermediate output image obtained by sharpening the input image, instead of convolving the sharpening filter in step S106. The machine learning model may use the correction strength as input data. The correction strength according to the present exemplary embodiment of the disclosure is not the difference of the correction effect based on the difference of the first optical characteristic but the degree of correction of the blur based on the first optical characteristic. In the present exemplary embodiment, the weight in the weighted sum of the input image and the intermediate output image is the correction strength. In other words, the higher the weight for the input image is, the smaller the correction strength is. Furthermore, in a case where the sharpening process using the machine learning model is performed, the correction strength can be adjusted by a weighted sum of the intermediate output image and the input image generated using the machine learning model. The aspect of the embodiments is not limited to the above described method, but the correction strength in the sharpening process can be adjusted using learning data including a pair of a training image and a ground truth image relatively small in the difference therebetween.

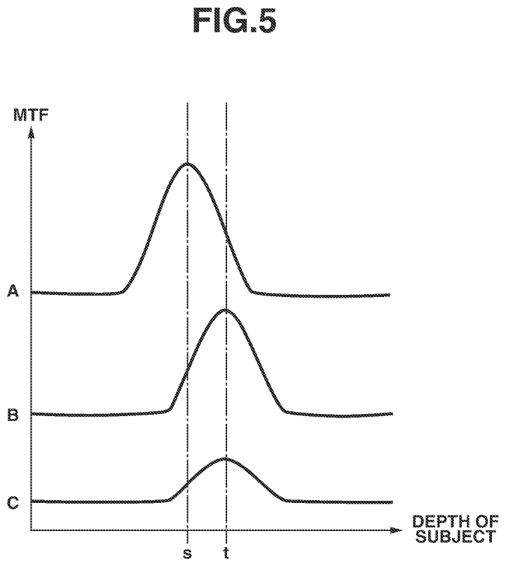

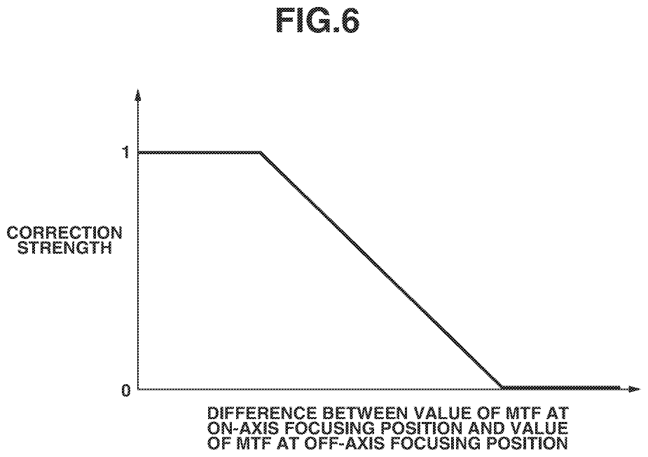

With reference to FIGS. 5 and 6, the correction strength is described. FIG. 5 is a diagram illustrating a change in the MTF with respect to the depth of the subject. FIG. 6 is a diagram illustrating the correction strength. In the present exemplary embodiment, on the assumption that blur due to the astigmatism is sufficiently small, only defocus due to the field curvature is taken into account. In FIG. 5, the vertical axis represents the value of the MTF at a predetermined spatial frequency, and the horizontal axis represents the depth of the subject. FIG. 5 also illustrates an on-axis focusing position s and an off-axis focusing position t in the depth of the subject. Although the MTF is used as an optical characteristic in the present exemplary embodiment, the disclosure is not limited to this.

In FIG. 5, a case A indicates a change in the MTF with respect to the depth of the subject in a partial area including a position on the axis. In the case A in FIG. 5, the depth of the subject indicating the highest MTF is set as the on-axis focusing position s. That is, the optical system 101 focuses on the subject away by the on-axis focusing position s from the optical system 101 on the axis. A case B indicates a change in the MTF in a sagittal direction with respect to the depth of the subject in a partial area off the axis having any image height. In the case B, the depth of the subject indicating the highest MTF is set as the off-axis focusing position t. A case C indicates a change in the MTF in a meridional direction with respect to the depth of the subject in a partial area off the axis having the same image height as in the case B. The on-axis focusing position s and the off-axis focusing position t differ according to the image height and the field curvature.

In a case where the astigmatism is taken into account, in addition to the difference in the MTF in the sagittal direction, the difference in the MTF in the meridional direction may also be obtained. In this case, the correction strength may be set based on a value in an azimuth direction in which the difference in the MTF is greater, and the correction strength may be acquired with respect to each azimuth direction. The on-axis focusing position s and the off-axis focusing position t differ according to the field curvature.

In FIG. 5, in a case where the subject having the image height corresponding to the case B is present at a depth different from that of the subject on the axis corresponding to the case A, or in a case where the optical system 101 focuses on a subject off the axis, an optical characteristic may be high at the position corresponding to the case B than at the position corresponding to the case A. In such a case, excessive correction may occur in the partial area corresponding to the case B.

The horizontal axis in FIG. 5 represents the depth of the subject, but may represent the image plane position corresponding to an optical characteristic. Optical characteristics do not exactly match each other between a case where the depth of the subject is changed and a case where the image plane position is changed. However, in a case where the amount of change in the depth is sufficiently small, the optical characteristics can be regarded as equivalent to each other.

In the present exemplary embodiment, to prevent excessive correction, the correction strength is set based on an optical characteristic at the off-axis focusing position t (the second optical characteristic). In the present exemplary embodiment, the MTF is used as the optical characteristic. The aspect of the embodiments, however, is not limited to this. For example, as illustrated in FIG. 6, the correction strength can be set based on the difference between the value of the MTF at the on-axis focusing position s and the value of the MTF at the off-axis focusing position t. At this time, the correction strength is set so that the greater the difference between the values of the MTFs is, the smaller the correction strength is. As described above, the correction strength is set based on the position of the highest-performance optical characteristic (the off-axis focusing position t) among optical characteristics that differ according to the depth of the subject, whereby it is possible to prevent excessive correction in the sharpening process. The correction strength according to the present exemplary embodiment is not limited to this, and may be set at least based on the second optical characteristic.

For example, the correction strength may be set based on the ratio between the value of the MTF at the on-axis focusing position s and the value of the MTF at the off-axis focusing position t. At this time, the correction strength is set so that the higher the performance of the second optical characteristic is relative to the first optical characteristic, the smaller the correction strength is. Thus, it is possible to prevent excessive correction in the sharpening process. The first and second optical characteristics correspond to the first and second defocus amounts, respectively. Thus, the setting may be performed so that the smaller the second defocus amount is relative to the first defocus amount, the smaller the correction strength is. The correction strength may also be set based only on the MTF at the off-axis focusing position t (the second optical characteristic). For example, the correction strength is set so that the higher the performance of the second optical characteristic is, the smaller the correction strength is. Thus, it is possible to prevent excessive correction in the sharpening process. The setting may be performed so that the smaller the second defocus amount is, the smaller the correction strength is.

In the present exemplary embodiment, the state where an optical characteristic has high performance refers to the state where the optical characteristic is evaluated based on a predetermined reference and has excellent performance. For example, the state where an optical characteristic has high performance corresponds to the state where the value of the MTF at a predetermined spatial frequency is great or the state where the spread amount of the point spread function (PSF) is small. The relationship between the correction strength and the second optical characteristic differs according to the image height, the imaging distance, or other imaging conditions, and therefore, the storage unit 108 holds information regarding the correction strength under imaging conditions in a table format.

The degree of excessive correction that occurs in the image differs with respect to each partial area (image height). Thus, in one embodiment, the correction strength according to the present exemplary embodiment differs according to the position of the partial area. In the case of a rotationally symmetric optical system, the field curvature and the astigmatism change according to the image height and are uniform in the rotation direction with respect to the optical axis. At this time, the degree of excessive correction may change according to the image height of the captured image, and may be uniform in the rotation direction with respect to the optical axis. In this case, only a change according to the image height is held as a change in the correction strength with respect to the partial area, whereby it is possible to reduce the amount of data for holding data of the correction strength.

Although the information acquisition unit 104c acquires the optical characteristics and the correction strength from the storage unit 108 of the imaging apparatus 100 in the present exemplary embodiment, the disclosure is not limited to this. For example, in the case of an imaging apparatus where the optical system 101 is detachably attached to a camera main body, the information acquisition unit 104c may acquire the optical characteristics and the correction strength stored in a storage unit in a lens device including the optical system 101 through communication with the imaging apparatus. In this case, the lens device (the optical system 101) includes a storage unit (not illustrated) that stores the optical characteristics and the correction strength, and a communication unit (not illustrated) that transmits the optical characteristics and the correction strength to the camera main body.

The optical characteristics and the correction strength may be held in advance on a server, instead of being stored in the imaging apparatus or the storage unit in the lens device. In this case, By communicating with the imaging apparatus or the lens device, where necessary, the optical characteristics and the correction strength can be downloaded.

Although the correction strength is acquired from the storage unit 108 in the present exemplary embodiment, a value (an index value) such as the MTF may be acquired from the storage unit 108, and the correction strength may be obtained from the index value. With this configuration, it is possible to set correction strength that differs with respect to each imaging apparatus or each optical system.

The first optical characteristic according to the present exemplary embodiment is an optical characteristic in a case where on a subject on a plane a predetermined imaging distance away from the optical system 101 and perpendicular to the optical axis, the optical system 101 focuses on the axis. That is, the defocus amount for calculating the first optical characteristic (the first defocus amount) matches the field curvature amount at each image height. On the other hand, the second optical characteristic according to the present exemplary embodiment is an optical characteristic at an off-axis image height included in a partial area and is an optical characteristic in a case where the optical system 101 focuses on the subject off the axis. At the focusing position, ideally, the second defocus amount is zero, and the optical system 101 has the highest-performance optical characteristic at the image height.

That is, the optical system 101 is in the least blurred state. The correction strength is acquired based on the optical characteristic in the least blurred state, whereby it is possible to prevent excessive correction in the sharpening process based on the first optical characteristic.

In the present exemplary embodiment, since a rotationally symmetric optical system is assumed, the optical system focuses on the subject on the axis. However, under general conditions including a rotationally asymmetric optical system, the optical system may focus on the subject at a predetermined reference image height or in a partial area including the predetermined reference image height. To prevent excessive correction in the sharpening process, the second defocus amount may not be exactly zero so long as the second defocus amount is smaller than the first defocus amount.

Next, the configuration of an imaging apparatus according to a second exemplary embodiment is described. In the first exemplary embodiment, it is assumed that the astigmatism is sufficiently small. In the present exemplary embodiment, a case is described where the magnitude of the astigmatism cannot be ignored. A flowchart regarding a sharpening process according to the present exemplary embodiment is the same as that according to the first exemplary embodiment.

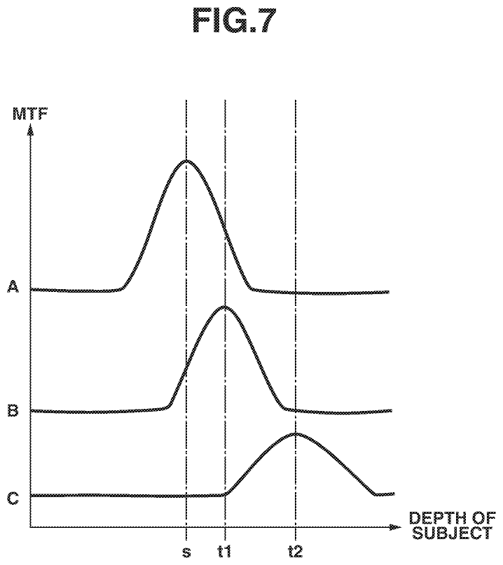

With reference to FIG. 7, the correction strength in an optical system having astigmatism is described in detail. FIG. 7 is a diagram illustrating a change in the MTF with respect to the depth of the subject. In FIG. 7, the vertical axis represents the value of the MTF at a predetermined spatial frequency, and the horizontal axis represents the depth of the subject. The MTF is a value. FIG. 7 also illustrates an on-axis focusing position s, a focusing position t1 in a sagittal direction off the axis, and a focusing position t2 in a meridional direction off the axis in the depth of the subject at any object height. In the present exemplary embodiment, the MTF is used as an optical characteristic. Azimuth directions are not limited to the sagittal direction and the meridional direction, and may be a first direction and a second direction different from each other among a plurality of azimuth directions.

Since the astigmatism is taken into account in the present exemplary embodiment, the present exemplary embodiment is different from the first exemplary embodiment in that the focusing positions t1 and t2 differ with respect to each azimuth direction even in the same off-axis area. The correction strength according to the present exemplary embodiment is acquired based on an optical characteristic at the focusing position with respect to each azimuth direction. For example, the correction strength in a partial area including a certain image height is acquired based on the greater value (the optical characteristic having the higher performance) between the value of the MTF at the focusing position t1 and the value of the MTF at the focusing position t2.

With this configuration, it is possible to prevent excessive correction in the sharpening process performed on an image acquired using an optical system having astigmatism.

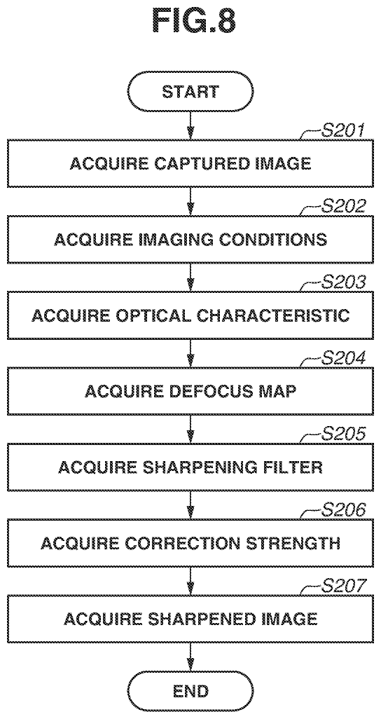

The sharpening process performed by the image processing unit 104 is specifically described below in exemplary embodiments. FIG. 8 is a flowchart regarding the sharpening process according to a third exemplary embodiment. The sharpening process according to the third exemplary embodiment is executed based on an instruction from the image processing unit 104. Steps in FIG. 8 are mainly executed by the image acquisition unit 104a, the imaging condition acquisition unit 104b, the information acquisition unit 104c, and the processing unit 104d.

In step S201, the image acquisition unit 104a acquires an image captured by the imaging apparatus 100 as an input image. In the present exemplary embodiment, the input image is parallax images corresponding to a plurality of viewpoints. The input image is saved in the storage unit 108. Alternatively, the image acquisition unit 104a may acquire an image saved in the image recording medium 109 as the input image.

In step S202, the imaging condition acquisition unit 104b acquires the imaging conditions when the input image is captured, where necessary. The imaging conditions include the focal length of the optical system 101, the stop value, and the imaging distance determined with respect to a subject in focus. In the case of an imaging apparatus in which a lens is interchangeably attached to a camera main body, the imaging conditions may further include a lens identifier (ID) and a camera ID. The imaging conditions may be directly acquired from the imaging apparatus 100, or may be acquired from information attached to the input image. For example, the information attached to the input image is exchangeable image file format (Exif) information.

In step S203, the information acquisition unit 104c acquires an optical characteristic (the first optical characteristic) of the optical system 101 from the storage unit 108. The first optical characteristic is an optical characteristic of the optical system 101 when the optical system 101 is defocused by the first defocus amount. The first defocus amount is a value based on the aberration of the optical system 101 and differs with respect to each image height. As the optical characteristic, for example, the OTF, the PSF, or coefficient data of a function approximately representing the PSF or the OTF may be acquired. Further, in the present exemplary embodiment, the aberration is field curvature. The aberration is not limited to this, and may be astigmatism. The storage unit 108 may discretely store optical characteristics for imaging conditions and screen positions (image heights and bearings), and an optical characteristic in each partial area may be acquired using the interpolations of the imaging conditions and the screen positions.

In step S204, based on the captured image acquired in step S201, the information acquisition unit 104c acquires information regarding the subject distance using the above method. For example, the information regarding the subject distance is acquired by the above pupil division method. In the present exemplary embodiment, the information regarding the subject distance is a map (a defocus map) obtained by, based on the above pupil division method, two-dimensionally arranging a subject defocus amount based on the subject distance corresponding to the subject in each partial area in the image. That is, the defocus map is the distribution of a defocus value indicating the degree of focusing when the captured image is acquired, with respect to each position in the image. In one embodiment, the defocus map includes values corresponding to the entirety of the image and have as many pixels as the captured image. Although the information regarding the subject distance is the defocus map in the present exemplary embodiment, the disclosure is not limited to this. Further, step S204 may be executed, regardless of whether before, between, or after steps S202, S203, and S205.

In step S205, the processing unit 104d acquires a sharpening filter. In the present exemplary embodiment, the sharpening filter is acquired based on the first optical characteristic at a position corresponding to each partial area using equation (6). The first optical characteristic at each position in the input image differs, and therefore, the sharpening filter applied to each position in the input image differs.

In step S206, the information acquisition unit 104c acquires correction strength. The correction strength according to the present exemplary embodiment is acquired based on the subject defocus amount corresponding to each partial area. The details of the correction strength will be described below.

In step S207, based on the sharpening filter and the correction strength, the processing unit 104d executes the sharpening process. In the sharpening process, first, the processing unit 104d convolves the sharpening filter into the input image, thereby acquiring an intermediate output image obtained by sharpening the input image. Then, the processing unit 104d obtains a weighted sum of the input image and the intermediate output image based on the correction strength, thereby adjusting a correction effect.

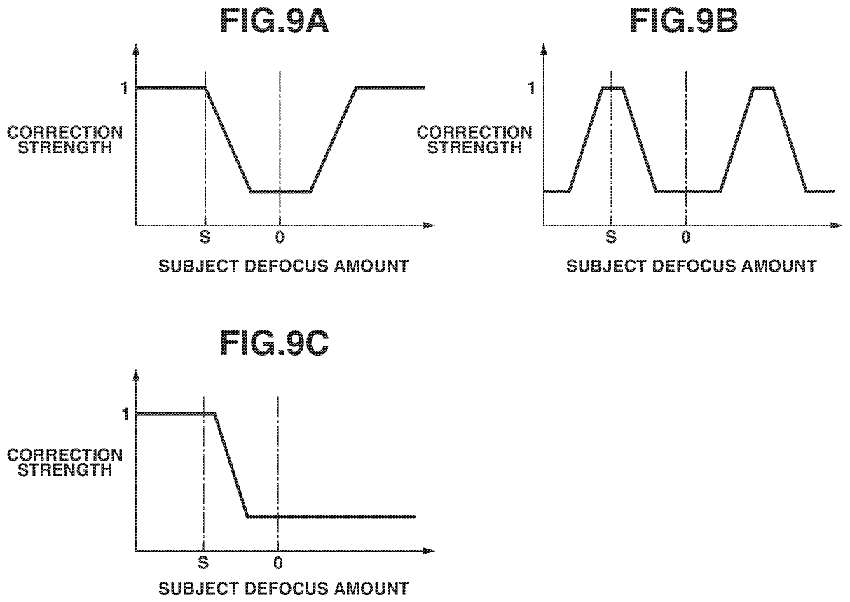

With reference to FIGS. 5 and 9A to 9C, the correction strength is described. FIG. 5 is a diagram illustrating a change in the MTF with respect to the depth of the subject in a certain area. FIGS. 9A to 9C are diagrams illustrating the correction strength. In the present exemplary embodiment, on the assumption that blur due to the astigmatism is sufficiently small, only defocus due to the field curvature is taken into account.

Next, with reference to FIGS. 9A to 9C, the correction strength in an off-axis partial area is described. Each of FIGS. 9A to 9C is an example of the relationship between the correction strength and the subject defocus amount. In each of FIGS. 9A to 9C, the vertical axis represents the correction strength with respect to any partial area, and the horizontal axis represents the subject defocus amount.

In FIGS. 9A to 9C, the subject defocus amount of a subject having a depth corresponding to the focusing position t of the off-axis partial area is 0. The first defocus amount corresponding to the first optical characteristic is S. In FIGS. 9A to 9C, the correction strength is set so that the correction strength is greatest in a case where the subject defocus amount is S. The aspect of the embodiments, however, is not limited to this. In one embodiment, the correction strength is set so that the correction strength is smaller in a case where the subject defocus amount is 0 than in a case where the first defocus amount and the subject defocus amount are equal to each other.

In the process of sharpening blur due to the first optical characteristic, in a case where blur occurs based on an optical characteristic different from the first optical characteristic due to the depth of the subject, excessive correction can occur. Thus, the subject defocus amount with respect to each image height is acquired based on the subject distance, and the correction strength for the sharpening process is set based on the subject defocus amount, whereby it is possible to reduce an adverse effect in the sharpening process.

As illustrated in FIG. 9A, the correction strength is set so that the correction strength is small in an area where the absolute value of the subject defocus amount is smaller than the defocus amount S corresponding to the on-axis focusing position s. This is because the closer to zero the absolute value of the subject defocus amount is, the higher the optical performance at the corresponding image height is, and the more likely excessive correction is to occur. Since it is only necessary to reduce an adverse effect due to excessive correction, the minimum value of the correction strength may not be zero. As described above, the correction strength is set according to the subject defocus amount, whereby it is possible to prevent excessive correction. In the present exemplary embodiment, the state where an optical characteristic has high performance refers to the state where the optical characteristic is evaluated based on a predetermined reference and has excellent performance. For example, the state where an optical characteristic has high performance corresponds to the state where the value of the MTF at a predetermined spatial frequency is great or the state where the spread amount of the point spread function (PSF) is small.

As illustrated in FIG. 9B, also in a case where the absolute value of the subject defocus amount is too great relative to the defocus amount S, the correction strength may be made small. That is, in a case where the difference between the optical characteristic acquired in step S203 and the optical characteristic in the actual subject is great, the correction strength is made small even under a condition where excessive correction does not occur. With this configuration, in a case where a desired defocus amount is handled, it is possible to obtain the effect of the sharpening process in a concentrated manner. As described above, the correction strength may differ between a case where the defocus amount changes in the positive direction with respect to the defocus amount S and a case where the defocus amount changes in the negative direction with respect to the defocus amount S. If the absolute value of the subject defocus amount is greater than a value obtained by multiplying the absolute value of the defocus amount S by any coefficient or a value obtained by adding any coefficient to the absolute value of the defocus amount S, the correction strength may be decreased. The range where the correction strength is decreased may be determined based on the focal length or the imaging distance of the optical system used for the image capturing.

As illustrated in FIG. 9C, the correction strength may be asymmetric in the positive and negative directions based on a case where the defocus amount is zero. In a case where the defocus amount S is negative, and even if the defocus amount changes further in the negative direction, excessive correction does not occur. On the other hand, in a case where the defocus amount S changes in the positive direction, the correction strength is made smaller, whereby it is possible to prevent excessive correction. The same applies to a case where the defocus amount S is positive.

With this configuration, even if the acquisition accuracy of the subject defocus amount or information regarding the subject distance is low, the correction strength is determined based on the relative magnitude relationship with the defocus amount S, whereby it is possible to obtain the effect of preventing excessive correction. The above information regarding the correction strength for the subject defocus amount is held in a table format.

As illustrated in FIGS. 9A to 9C, the correction strength may be asymmetric with respect to a straight line passing through (S, 0) in each of the positive and negative directions and orthogonal to the x-axis.

The amount (degree) of excessive correction for the subject defocus amount changes according to the difference between the value of the MTF at the on-axis focusing position s and the value of the MTF at the off-axis focusing position t, the image height, the imaging distance, or the imaging conditions. For example, the correction strength may be acquired based on the difference between the value of the MTF at the on-axis focusing position s and the value of the MTF at the off-axis focusing position t, the image height, the imaging distance, or the imaging conditions in addition to the subject defocus amount. For example, the correction strength may be set so that the greater the value of the MTF at the off-axis focusing position t is relative to the value of the MTF at the on-axis focusing position s, the smaller the minimum value of the correction strength is. Alternatively, the above processing may be applied only to an image height or imaging conditions with which the difference between the value of the MTF at the on-axis focusing position s and the value of the MTF at the off-axis focusing position t is great. The storage unit 108 holds the above information such as the imaging conditions, where necessary.

Next, the configuration of an imaging apparatus according to a fourth exemplary embodiment is described. In the present exemplary embodiment, similarly to the second exemplary embodiment, a case is described where the magnitude of the astigmatism cannot be ignored. A flowchart regarding a sharpening process according to the present exemplary embodiment is the same as that according to the third exemplary embodiment.

Since the astigmatism is taken into account in the present exemplary embodiment, the present exemplary embodiment is different from the third exemplary embodiment in that the focusing positions t1 and t2 differ with respect to each azimuth direction even in the same off-axis area. The correction strength according to the present exemplary embodiment is acquired based on the difference between the focusing position with respect to each azimuth direction and the subject distance (the subject defocus amount). For example, the correction strength in a partial area including a certain image height is acquired based on the smaller value (the optical characteristic having the higher performance) between the subject defocus amount at the focusing position t1 and the subject defocus amount at the focusing position t2.

With this configuration, it is possible to prevent excessive correction in the sharpening process performed on an image acquired using an optical system having astigmatism.

### Other Exemplary Embodiments

The aspect of the embodiments can also be achieved by the process of supplying a program for achieving one or more functions of the above exemplary embodiments to a system or an apparatus via a network or a storage medium, and of causing one or more processors of a computer of the system or the apparatus to read and execute the program. The aspect of the embodiments can also be achieved by a circuit (e.g., an ASIC) for achieving the one or more functions. An image processing apparatus, according to the aspect of the embodiments is an apparatus having an image processing function according to the aspect of the embodiments, and can be achieved in the form of an imaging apparatus or a personal computer (PC).

According to the exemplary embodiments, it is possible to provide an image processing method, an image processing apparatus, and a program that are capable of performing a sharpening process in which excessive correction due to the depth of a subject is prevented, while reducing the amount of data and the calculation load.

While Exemplary embodiments of the disclosure have been described above, the disclosure is not limited to these exemplary embodiments, and can be modified and changed in various ways within the scope of the disclosure.

### Other Embodiments

Embodiment(s) of the disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Applications No. 2022-166377, filed Oct. 17, 2022, and No. 2022-190038, filed Nov. 29, 2022, which are hereby incorporated by reference herein in their entirety.

What is claimed is:

1. An image processing method comprising:
acquiring a captured image obtained by image capturing using an optical system;
acquiring correction strength for a sharpening process applied to a partial area in the captured image; and
applying the sharpening process to the partial area based on a first optical characteristic and the correction strength,
wherein the correction strength is acquired based on a second optical characteristic,
wherein the first optical characteristic is an optical characteristic of the optical system in a case where the optical system is defocused by a first defocus amount,
wherein the second optical characteristic is an optical characteristic of the optical system in a case where the optical system is defocused by a second defocus amount, and
wherein the second defocus amount is smaller than the first defocus amount.

2. The image processing method according to claim 1, wherein the first defocus amount is a defocus amount due to aberration of the optical system.

3. The image processing method according to claim 1, wherein the second defocus amount is a distance between an image forming position corresponding to a subject and a position of an image plane, in a case where the subject in the partial area is in focus.

4. The image processing method according to claim 3, wherein the second defocus amount is 0.

5. The image processing method according to claim 1, wherein the higher a performance of the second optical characteristic is, the smaller the correction strength is.

6. The image processing method according to claim 1, wherein the higher a performance of the second optical characteristic is relative to a performance of the first optical characteristic, the smaller the correction strength is.

7. The image processing method according to claim 1, wherein the sharpening process is a process of correcting blur corresponding to the first optical characteristics.

8. The image processing method according to claim 1, wherein the sharpening process is a process using a machine learning model.

9. The image processing method according to claim 1, wherein the correction strength is uniform in a rotation direction with respect to an optical axis of the optical system.

10. The image processing method according to claim 1, wherein the second defocus amount is a distance between an image forming position corresponding to a subject corresponding to one of a plurality of azimuth directions and a position of an image plane in a case where the subject in the partial area is in focus.

11. An image processing apparatus comprising a processing unit configured to execute the image processing method according to claim 1.

12. An image processing system comprising:
the image processing apparatus according to claim 11; and
an imaging apparatus including the optical system and configured to acquire the captured image.

13. An imaging apparatus comprising:
a processing unit configured to execute the image processing method according to claim 1; and
an imaging unit including the optical system and configured to acquire the captured image.

14. A storage medium storing a program for causing a computer to execute the image processing method, the method comprising:
acquiring a captured image obtained by image capturing using a system;
acquiring correction strength for a sharpening process applied to a partial area in the captured image; and
applying the sharpening process to the partial area based on a first characteristic and the correction strength,
wherein the correction strength is acquired based on a second characteristic,
wherein the first characteristic is a characteristic of the system in a case where the system is defocused by a first defocus amount,
wherein the second characteristic is a characteristic of the system in a case where the system is defocused by a second defocus amount, and
wherein the second defocus amount is smaller than the first defocus amount.

15. An image processing method comprising:
acquiring a captured image obtained by image capturing using an optical system;
acquiring a subject defocus amount in a partial area in the captured image;
based on the subject defocus amount, acquiring correction strength for a sharpening process applied to the partial area; and
applying the sharpening process based on a first optical characteristic and the correction strength,
wherein the first optical characteristic is an optical characteristic of the optical system in a case where a defocus amount of the optical system is a first defocus amount, and
wherein the correction strength is smaller in a case where the subject defocus amount is 0 than in a case where the subject defocus amount is equal to the first defocus amount.

16. The image processing method according to claim 15, wherein the first defocus amount is a defocus amount with respect to each image height due to aberration of the optical system.

17. The image processing method according to claim 15,
wherein the captured image is a plurality of parallax images corresponding to a plurality of viewpoints, and
wherein the subject defocus amount is acquired based on the plurality of parallax images.

18. The image processing method according to claim 17, wherein the subject defocus amount is a defocus map that is distribution of a defocus value indicating a degree of focusing when the captured image is acquired, with respect to each position in the image.

19. The image processing method according to claim 15, wherein in a case where a y-axis represents the correction strength, and an x-axis represents a defocus amount of the optical system, and a change in the correction strength with respect to the defocus amount is indicated, the correction strength is asymmetric with respect to a straight line passing through (first defocus amount, 0) and orthogonal to the x-axis.

20. The image processing method according to claim 1, wherein in a case where a y-axis represents the correction strength, and an x-axis represents a defocus amount of the optical system, and a change in the correction strength with respect to the defocus amount is indicated, the correction strength is asymmetric with respect to a straight line passing through (0, 0) and orthogonal to the x-axis.

21. The image processing method according to claim 15, wherein the correction strength is based on a subject defocus amount in a first direction among a plurality of azimuth directions in the partial area and a subject defocus amount in a second direction different from the first direction among the plurality of azimuth directions.

22. An image processing apparatus comprising a processing unit configured to execute the image processing method according to claim 15.

23. An image processing system comprising:
the image processing apparatus according to claim 22; and
an imaging apparatus including the optical system and configured to acquire the captured image.

24. An imaging apparatus comprising:
a processing unit configured to execute the image processing method according to claim 15; and
an imaging unit including the optical system and configured to acquire the captured image.

25. The imaging apparatus according to claim 24,
wherein the imaging unit includes an image sensor including pixels having a plurality of light-receiving units, and
wherein the plurality of light-receiving units receives beams passing through pupils different from each other.

26. A storage medium storing a program for causing a computer to execute the method, the method comprising:
acquiring a captured image obtained by image capturing using a system;
acquiring a subject defocus amount in a partial area in the captured image;
based on the subject defocus amount, acquiring correction strength for a sharpening process applied to the partial area; and
applying the sharpening process based on a first characteristic and the correction strength,
wherein the first characteristic is a characteristic of the system in a case where a defocus amount of the system is a first defocus amount, and
wherein the correction strength is smaller in a case where the subject defocus amount is 0 than in a case where the subject defocus amount is equal to the first defocus amount.
